(19) United States
(12) Patent Application Publication
(10) Pub. No.: US 2008/0292271 A1
(43) Pub. Date: Nov. 27, 2008

(54) Visual and audio data recording and reproducing apparatus

(75) Inventor: Takuma Tsukuda, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd. Incorporation, Tokyo (JP)

(21) Appl. No.: 12/002,846

(22) Filed: Dec. 18, 2007

(30) Foreign Application Priority Data
Jan. 30, 2007 (JP) 2007-018670

(51) Int. Cl. H04N 5/91

(52) U.S. Cl. 386/95

(57) ABSTRACT

When external input data is recorded on a HD and an optical disc, recording on both discs is executed in intermittent recording fashion or recording on the optical disc is executed in low speed continuous recording fashion. During recording on both the HD and the optical disc, the residual amount of optical disc becomes slight, recording on the HD is allowed to continue, recording on the optical disc is paused while holding a position indicating how far recording on the optical disc has proceeded and after exchange of the optical disc, dubbing to a replaced optical disc is started from the stop position. During mere dubbing, recording on the optical disc is paused while holding a position indicating how far recording on the optical disc has proceeded and after exchange of the optical disc, dubbing to a replaced optical disc is started from the stop position.

### INCORPORATION BY REFERENCE

The present application claims priority from Japanese application JP2007-018670 filed on Jan. 30, 2007, the content of which is hereby incorporated by reference into this application.

### BACKGROUND OF THE INVENTION

The present invention relates to a visual and audio data recording and reproducing apparatus for recording and reproducing visual and audio data on and from a recording medium.

A technique disclosed in JP-A-2004-241093 is available for reducing power consumption in a disk drive such as a HDD (Hard Disc Drive) and an optical disk drive. In the disclosed technique, a data processor controls the power consumption mode of a HDD in accordance with a control state of the HDD.

Power saving control in a camera using a combined HDD/optical disc drive is disclosed in JP-A-2006-286034, according to which during normal recording operated with a battery, only the HDD drive is operated whereas operation of the optical disc drive is stopped.

A technique of recording on a HD (Hard Disc) and an optical disc is available as disclosed in JP-A-2003-101915. The literature JP-A-2003-101915 gives, in paragraph (0034), a description “With a HDD21 placed in recording operation condition, a disc drive 20 is controlled to a recording operation condition as shown at (c) in FIG. 3 and, in paragraph (0044), a description “The HDD 21 is controlled to a recording stop condition and at the same time the disc drive 20 is controlled to a recording operation condition as shown at (c) in FIG. 5. Through this, . . . recording on only an optical disc 20a is performed.” and besides, in paragraph (0045), a description “The HDD 21 is controlled to the recording operation condition and at the same time the disc drive 20 is controlled to the recording stop condition as shown at (c) in FIG. 5. Through this, . . . recording on only a hard disc 21a is performed.”

Recently, widespread use of a recorder and a camera each mounted with a HDD and a DVD (Digital Versatile Disc) drive has been prevailing. In general, the HD has a large capacity but is unexchangeable, whereas the DVD has a small capacity but is exchangeable. Long time recording is possible with the HDD but because of an upper limit of the recording capacity, data needs to be dubbed to an optical disc such as a DVD.

Further, a camera mounted with a HDD and a DVD drive can be used in such a manner that an image is first recorded on a HD and thereafter, the image is dubbed to a DVD. In this manner of use, however, much time is consumed for the sake of dubbing.

### SUMMARY OF THE INVENTION

Data being dubbed to the DVD will sometimes overflow. Then, highly efficient dubbing has been tasked.

To solve the above problem, according to the present invention, when input information applied externally is recorded on both of first and second recording media, recording on the first and second recoding media is performed intermittently or recording on the second recoding medium is performed continuously at a low speed.

Further, when the residual amount of the second recording medium becomes slight as recording on both the first and second recording media proceeds, recording on the first recording medium is kept up, recording on the second recording medium is stopped while holding a position indicating how far recording on the second recording medium has proceeded and after the second recording medium has been exchanged, dubbing to a replaced recording medium is started from the stop position. Even during mere dubbing, recording on the second recording medium is stopped while holding a position indicating how far recording on the second recording medium has proceeded and after exchange of the second recording medium, dubbing to a replaced second recording medium is started from the stop position.

When visual and audio data is recorded, the degree of easy-to-use capability can be improved and the degree for user's convenience sake can be promoted.

Other objects, features and advantages of the invention will become apparent from the following description of the embodiments of the invention taken in conjunction with the accompanying drawings.

### BRIEF DESCRIPTION OF THE DRAWINGS

FIG. 1A is a block diagram showing the overall construction of a visual and audio data recording and reproducing apparatus in a first embodiment of the present invention.

FIG. 1B is a block diagram showing the visual and audio data flow and the average recording speed.

FIGS. 2A and 2B illustrate examples of intermittent operation of the visual and audio data recording and reproducing apparatus in the invention, respectively.

FIG. 3 is a waveform diagram useful to explain the operation of the visual and audio data recording and reproducing apparatus in the first embodiment of the invention.

FIG. 4 is a waveform diagram useful to explain an example of operation of the visual and audio data recording and reproducing apparatus in a second embodiment of the invention.

FIG. 5 is a waveform diagram useful to explain another example of operation of the visual and audio data recording and reproducing apparatus in the second embodiment of the invention.

FIGS. 6A and 6B are waveform diagrams useful to explain further examples of operation of the visual and audio data recording and reproducing apparatus in the second embodiment of the invention, respectively.

FIG. 7 is a diagram illustrating an example of display in the visual and audio data recording and reproducing apparatus in a third embodiment of the invention.

### DESCRIPTION OF THE EMBODIMENTS

A visual and audio data recording and reproducing apparatus according to the present invention will now be described with reference to the accompanying drawings.

### Embodiment 1

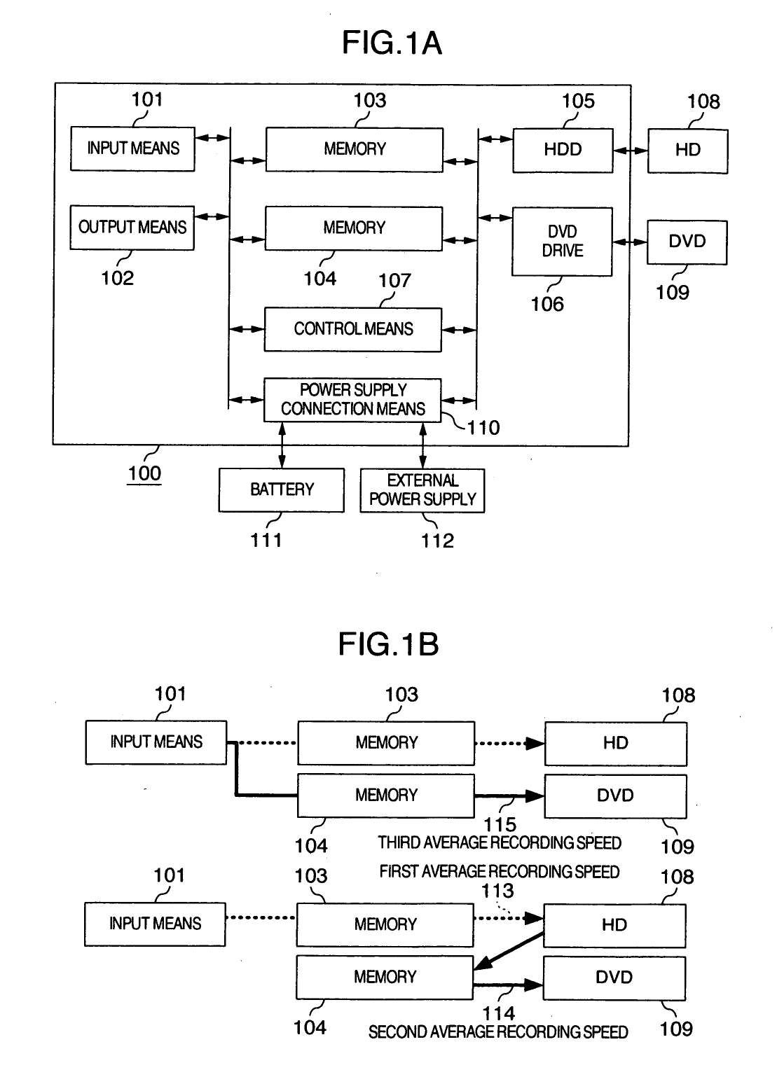

The construction of a visual and audio data recording and reproducing apparatus 100 will be described by way of example of a camera by making reference to FIG. 1A.

An input means 101 includes a pick-up device constructed of a lens and CMOS's (Complementary Metal Oxide Semiconductors) and a signal processing circuit for encoding an electric signal obtained from the pick-up device in conformity with a recording format of a HD or an optical disc.

In a first temporary storage medium 103, visual and audio data inputted through the input means 101 is temporarily held. Used as the storage medium is such a memory as a RAM (Random Access Memory). The first temporary storage medium will hereinafter be labeled memory 103.

Likewise, a second temporary storage medium 104 holds temporarily the visual and audio data inputted through the input means 101, and a RAM, for example, is used as the storage medium 104. Hereinafter, the second temporary storage medium will be labeled memory 104.

A first recording means 105 records on a first recording medium 108 the visual and audio data held by the memory 103. For example, a HDD is used as the first recording means 105 and hereinafter, the first recording means and the first recording medium will be labeled HDD and HD, respectively.

A second recording means 106 records on a second recording medium 109 the data held by the memory 104. A DVD or an optical disc of blue-ray is used as the second recording medium 109 and for example, the second recording means and the second recording medium will hereinafter be labeled DVD drive and DVD, respectively.

In FIG. 1A, the HD 108 and DVD 109 are both illustrated as being mountable to and dismountable from the visual and audio data recording and reproducing apparatus but one of them may be built in the visual and audio data recording and reproducing apparatus.

For outputting data, an output means 102 includes a signal processing circuit for decoding visual and audio data, an interface for transmission of signals, a display for displaying visual data and a loudspeaker for outputting audio data.

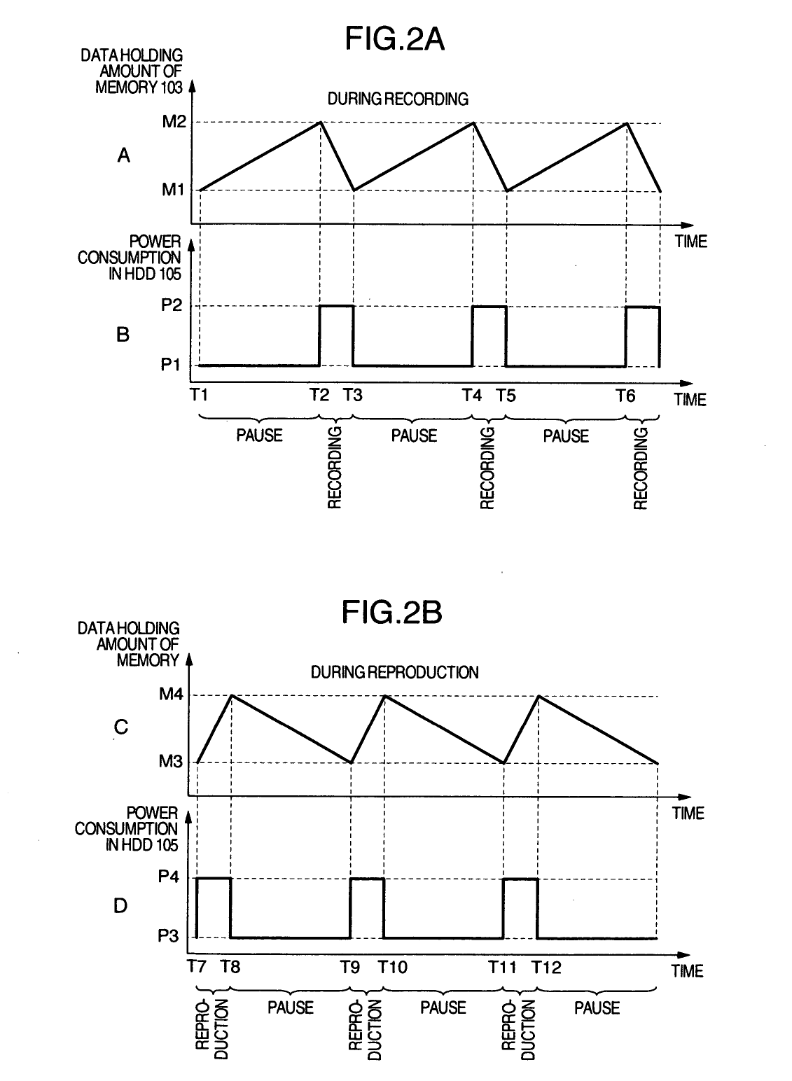

Referring to FIGS. 2A and 2B, examples of operation of the memory 103 and HDD 105 will be described. Operation during recording is depicted at A and B in FIG. 2A, indicating the data holding amount of memory 103 at section A and power consumption of or in HDD 105 at section B.

When visual and audio data comes to the memory 103 via the input means 101, the data holding amount of memory 103 increases during a time interval of from T1 to T2 as shown at A in FIG. 2A. During this period, power consumption of the HDD 105 is suppressed as shown at B in FIG. 2, setting up a pause state of power at P1. The pause state is a standby state at such a minimum level of power as for holding a learning parameter necessary for the HDD to operate and for rapidly starting a LSI (Large Scale Integration). The HD 108 per se representing a magnetic disc either can continue rotating or can be stopped.

As soon as the data holding amount of memory 103 reaches an upper limit value M2 (time T2), the HDD 105 starts recording as shown at B in FIG. 2A, consuming power at P2. As recording proceeds, the data holding amount of memory 103 decreases from M2 to M1 starting from time T2 and ending in T3. In this manner, the HDD 105 repeats recording and pause in accordance with the data holding amount of memory 103.

Operation during reproduction is illustrated at C and D in FIG. 2B, with the data holding amount of the memory being depicted at section C and power consumption necessary for reproduction of the HD 108 being depicted at section D in FIG. 2B.

When data held by the HD 108 is reproduced, the data holding amount of the memory increases from M3 to M4 starting from time T7 and ending in time T8 as shown at C in FIG. 2B. During this interval of time, power at P4 is consumed. As soon as the data holding amount reaches M4, the HDD 105 stops reproducing and is brought into a pause. In the pause state, power at P3 is consumed. Subsequently, as the data holding amount of memory decreases to M3 (time T9), the HDD 105 resumes reproduction. In this manner, the HDD 105 operates to repeat reproduction and pause in accordance with the data amount the memory holds.

The operation which proceeds repeating the recording and pause or the reproduction and pause is called intermittent recording or intermittent reproduction, which is generally termed an intermittent operation.

The memory 104 and DVD drive 106 perform an intermittent operation similarly.

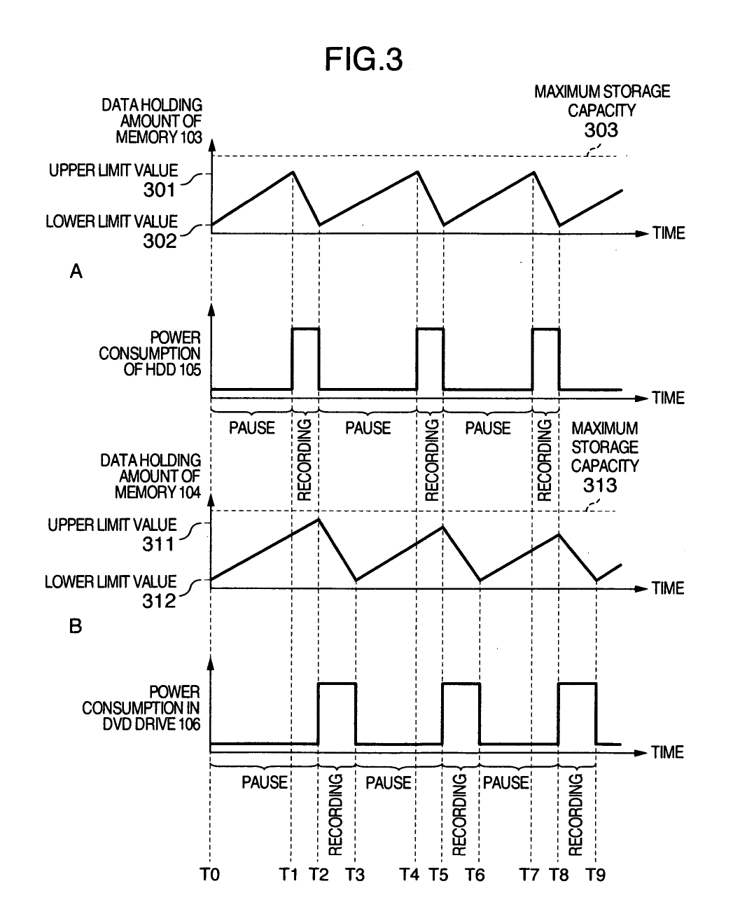

The present embodiment is featured in that visual and audio data inputted via the input means 101 is recorded on the HD and DVD and this feature will now be described with reference to FIG. 3. Storage of visual and audio data inputted through the input means 101 in both the memories 103 and 104 is stared (time T0). As shown at A in FIG. 3, when the data holding amount of memory 103 reaches an upper limit value 301 (time T1), the HDD 105 starts recording. The upper limit value 301 is less than a maximum storage capacity 303. Subsequently, as the data holding amount of memory 103 reaches a lower limit value 302 (time T2), recording is stopped. While recording by the HDD proceeds, the DVD drive 106 continues pausing in its recording (time T1 to time T2) as shown at B in FIG. 3.

As shown at B in FIG. 3, when the data holding amount of memory 104 reaches an upper limit value 311 (time T2), the DVD drive 106 starts recording. The data holding amount of memory 104 is so controlled as not to exceed a maximum storage capacity 313 by means of a control means 107. The upper limit value 311 is less than a maximum storage capacity 313. Then, as soon as the data holding amount of memory 104 reaches a lower limit value 312 (time T3), the DVD drive 106 stops recording, being brought into a pause state.

When the memory 103 comes subsequently to the upper limit value (time T4) as shown at A in FIG. 3, recording is started and thereafter, the HDD 105 and the DVD drive 106 each perform intermittent recording in a similar way.

As described above, the HDD 105 and DVD drive 106 are so controlled by the control means 107 as to perform recording alternately, so that recording on the HD and on the DVD can be executed, as though the execution were in parallel, with electric power level and power consumption similar to those for usual recording on either of the recoding media. Through this, the same visual and audio data can be recorded on the HD and DVD and time and labor, required when dubbing copy to the DVD is performed after completion of recording on the HD, can be dispensed with, giving rise to an advantage that efficient dubbing can be performed.

Recording on the HD 108 has been described herein as starting precedently but recording on the DVD 109 may start earlier. If the electric energy of a battery has an appreciable margin, the period of recording on the HD may overlap that of recoding on the DVD. Further, by causing the speed of recording on the recording media to be so controlled as to be slow, recoding on the DVD can be executed continuously.

### Embodiment 2

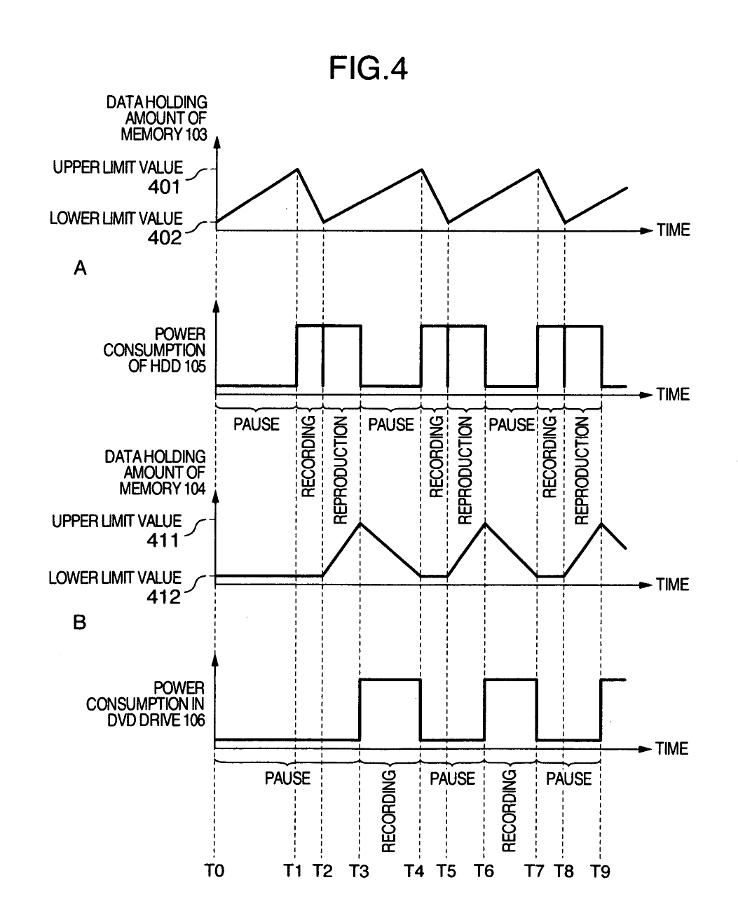

Referring to FIG. 4, an example will be described in which while recording second visual and audio data on the HD recorded with first visual and audio data, the first visual and audio data is dubbed to the DVD. The essential construction is similar to that in embodiment 1 and firstly, an instance will be described where the HDD 105 and the DVD 106 both perform intermittent recording.

As shown at A in FIG. 4, when storage of the second visual and audio data inputted via the input means 101 in the memory 103 is started (time T0), the data holding amount of memory 103 increases. As the data holding amount of the memory comes to an upper limit value 401 (time T1), recording on the HD 108 is started. Then, as the data holding amount of the memory falls to a lower limit value 402 (time T2), recording is stopped.

Subsequently, as shown at A in FIG. 4, the first visual and audio data held by the HD 108 is reproduced and storage of the data in the memory 104 is started (time T2). The data holding amount of memory 104 increases and when it reaches an upper limit value 411 (time T3), reproduction from the HD 108 is stopped and recording of the first visual and audio data from the memory 104 on the DVD 109 is started. As the data holding amount of the memory falls to a lower limit value 412 (time T4), recording is stopped.

Even within a period during which the HDD 105 performs reproduction or makes a pause, the visual and audio data from the input means 101 is stored in the memory 103 and when the upper limit value 401 is reached (time T4), recording on the HD 108 is started. Subsequently, the intermittent operation proceeds in a similar way.

To add, at the time of switching between recording end and reproduction start in association with the HD 108 (times T2, T5 and T8), at the time of switching between end of reproduction from the HD 108 and start of recording on the DVD 109 (times T3, T6 and T9) and at the time of switching between end of recording on the DVD 109 and start of recording on the HD 108 (times T4 and T7), there may be a period during which both the HDD 105 and the DVD drive 106 are brought into a pause condition. Further, power consumption for recording by the HDD may differ from that for reproduction thereby. Like embodiment 1, if the battery and electric energy are sufficient for capacity, the recording period on the HD 108 may overlap the recording period on the DVD 109 and besides, the reproduction period from the HD 108 may overlap the recording period on the DVD 109. In addition, recording on the DVD 109 may be executed continuously without pause. To add, after dubbing has been completed, operation may proceed to recording on both the HD 108 and the DVD 109 as in the case of embodiment 1.

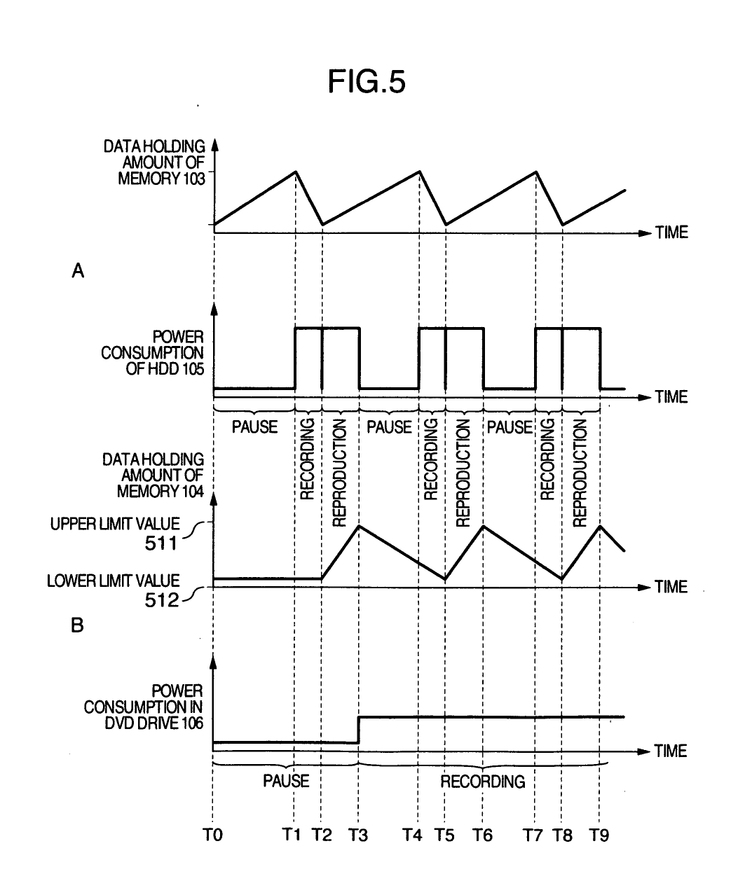

Another example of dubbing in the present embodiment will now be described with reference to FIG. 5. Exemplarily, the intermittent operation the HD 108 undergoes is similar to that in FIG. 4 but continuous recording is applied to recording on the DVD 109.

First visual and audio data from the HD 108 is stored in the memory 104 (times T2 to T3) and when the data holding amount of the memory reaches an upper limit value 511, recording on the DVD 109 is started (time T3). Thereafter, the data holding amount of the memory 104 is increased and deceased repeatedly in response to reproduction from the HD 108 and recording on the DVD 109 but the range of from upper limit value 511 to lower limit value 512 is not exceeded. No pause period is provided for recording on the DVD 109 and continuous recording proceeds.

It is supposed that the average recording speed of recording on the DVD 109 is faster than that of recording on the HD 108. Then, dubbing can end earlier and operation can proceed to recording on both the HD 108 and the DVD 109 as in the case of embodiment 1.

The average recording speed will be described herein by making reference to FIG. 1B. As shown in FIG. 1B, visual and audio data obtained from the input means 101 is stored in the memory 103 and is recorded on the HD 108 from the memory 103 at a first average recording speed 113. When recording on the HD 108 is stopped, visual and audio data in the HD 108 is reproduced and stored in the memory 104. Recording on the DVD 109 from the memory 104 is carried out at a second average recording speed 114.

The average recording speed is defined by division of the recording amount by the sum of recording time and pause time. For the same recording time, the average recording speed can be increased by making the recording speed per unit time higher. Conversely, for the same recording speed per unit time, the average recording speed can be faster by making the recording time longer.

From the standpoint of power consumption, the former is preferable. The present embodiment is featured in that the second average recording speed 114 is made to be faster than the first average recording speed 113. It will be appreciated that the second average recording speed 114 may be faster than a third average recording speed 115 on the DVD 109 when visual and audio data inputted via the input means 101 is recorded on both the HD 108 and the DVD 109.

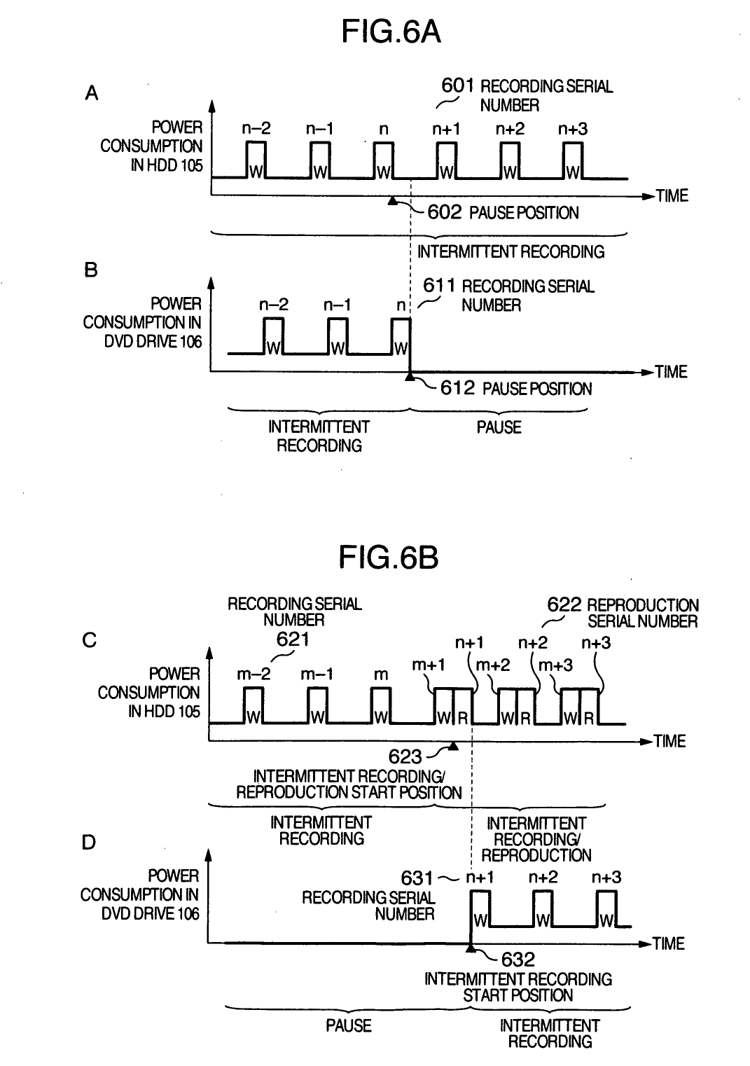

Next, an example where recording on the DVD 109 is paused and the DVD is exchanged will be described with reference to FIGS. 6A and 6B. In FIGS. 6A and 6B, W represents recording of visual and audio data and R represents its reproduction. When recording as in embodiment 1 is performed on both the HD 108 and the DVD 109, in a case that the capacity, for example, of the DVD 109 is then filled up, in that the DVD is therefore exchanged with a new one and thereafter recording is desired to continue on both the recording media, recording of a part of data prevailing after the exchange of the DVD is executed through dubbing as explained in connection with FIG. 4 or 5, thus permitting recording as in embodiment 1 to continue.

Visual and audio data inputted via the input means 101 is stored in the memories 103 and 104 and intermittent recording is carried out as shown at A and B in FIG. 6A and at C and D in FIG. 6B. Numerical numbers are assigned to individual recording events of intermittent recording so that a recording serial number 601 may be assigned for the HD 108 and a recording serial number 611 may be assigned for the DVD 109. If the recording permissible residual amount of the DVD 109 falls below a certain value and recording on the DVD 109 is paused at a moment when the recording serial numbers 601 and 611 are each n, the control means 107 holds pause positions 602 and 612 indicating how far recording of the visual and audio data on the DVD 109 has proceeded till then and allows recording on the HD 108 to continue. For holding the pause position, management data such as time from start of recording the visual and audio data and recorded amount thereof and address on the recording medium as well are held.

As shown at A in FIG. 6A, recording on the HD 108 continues in intermittent recording fashion and the serial number 601 increases through n+1, n+2 . . . . On the other hand, as shown at B in FIG. 6A, recording on the DVD 109 is paused and the power supply is turned off. The recording serial number 611 ends in n.

When visual and audio data inputted via the input means 101 is intermittently recorded on the HD 108 through m−2, m−1, m . . . of recording serial number 621 as shown at C in FIG. 6B, the control means 107 starts reproduction from an intermittent recording/reproduction start position 623. Immediately after an event of m+1 has been recorded on the HD 108, an n+1 event of reproduction serial number 622 is reproduced. The thus reproduced visual and audio data is stored in the memory 104 and is then recorded on a new replaced DVD 109 from a starting point of intermittent recording start position 632 as shown at D in FIG. 6B.

After the n+1 event of reproduction serial number 622, the same visual and audio data as those developing after an n+1 event of recording serial number 601 prevail. In this manner, the visual and audio data which will be recorded after n+1 of recording serial number 601 will be reproduced starting from n+1 of reproduction serial number 622 and sequentially recorded starting from n+1 of recording serial number 631. In this case, recording may be executed starting from either a number smaller than n+1 of recording serial number 631 or a number larger than n+1 of recording serial number 631. At a moment that operations at C and D in FIG. 6B end and the reproduction/recording comes up with an event now being recorded on the HD 108, operation for recording visual and audio data inputted via the input means 101 on both the HD and DVD as in embodiment 1 may be taken over. Recording on the DVD 109 may be executed not in intermittent recording fashion but in continuous recording fashion.

In addition to the instance where the DVD is exchanged during recording on both the HD and DVD as in the present embodiment, an instance may be adopted in which recording on the DVD is paused either in the course of dubbing from the HD to the DVD during recording on only the HD or in the course of only dubbing from the HD to the DVD and then, as in the case of the present embodiment, data as to how far reproduction from the HD has proceeded or how far recording on the DVD has proceeded is held, so that the exchange of the DVD can be achieved even during a so-called dubbing by utilizing the present embodiment in such a way that the pause position is used as a dubbing start position after the DVD exchange.

### Embodiment 3

Reverting to FIG. 1A, an example of the visual and audio data recording and reproducing apparatus 100 will be described which comprises a power supply connection means 110 capable of receiving electric power supplied from first and second power supplies 111 and 112. The first power supply 111 is a battery (hereinafter labeled battery 111) and the second power supply 112 is an external power supply (hereinafter labeled external power supply 112). The control means 107 monitors both the battery and the external power supply.

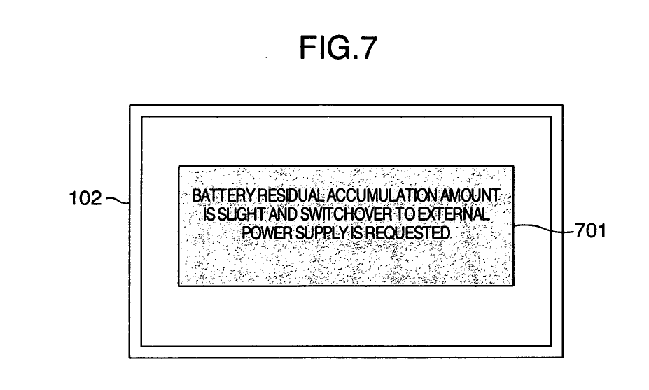

In the visual and audio data recording and reproducing apparatus 100 operating with the battery 111, recording on both the HD 108 and the DVD 109 as in embodiment 1 is executed and the control means 107 monitors the accumulation amount of battery 111 so as to cause the output means 102 to inform the user of switchover of power supply from the battery 111 to the external power supply 112 in the event that the accumulation amount falls below a predetermined level. An example of a display by the output means 102 is illustrated in FIG. 7. The display of output means 102 is performed with, for example, a liquid crystal display screen on which an alarm letter 701, for example, is displayed.

Also, in the visual and audio data recording and reproducing apparatus 100 operating with the battery 111, recording on both the HD 108 and the DVD 109 as in embodiment 1 is executed, the control means 107 monitors the accumulation amount of battery 111 so as to pause recording on the DVD 109 when the accumulation amount falls below a predetermined level. After the pause, recording on the HD 108 continues and recording on the DVD 109 stops.

Further, in the visual and audio data recording and reproducing apparatus 100 operating with the battery 111, dubbing from the HD 108 to the DVD 109 as in embodiment 2 is executed and the control means 107 monitors the accumulation amount of battery 111 so as to pause recording on the DVD 106 when the accumulation amount falls below a certain level.

Further, the control means 107 controls the battery and the external power supply so as to materialize continuous recording and duplex intermittent recording as well on the HDD 105 and the DVD drive 106 as in embodiments 1 and 2.

In the foregoing embodiments 1 to 3, the memories 103 and 104 may be merged into a single memory. Both the memory 103 and the memory 104 may be incorporated in a single memory or for example, areas may be put together and data may also be put together so that a pointer management as to how far recording of data on either HD or DVD has proceeded may be practiced.

According to the foregoing embodiments of the invention, visual and audio data can be recorded on both the HD and the optical disc such as DVD and therefore recording on the optical disc has been completed when recording ends, thus ensuring that in the case of a video camera, a mountable and dismountable optical disc transcribing persons of a family who attend together can be delivered to the family on the spot. For example, in the case of a recorder, a program not protected by copyright can be recorded as necessary on a HD and an optical disc as in the case of the aforementioned video camera and the dismountable optical disc can at once be utilized for a portable device, for instance. Further, recording on the HD and the DVD can be executed in intermittent operation and in addition, even continuous operation of continuous recording can be carried out at a low recording speed and a low power level, for instance.

Further, when dubbing data held in a HD to an optical disc during recording on the HD, recording speed of dubbing can be made faster than speed of recording on the HD in order that dubbing can gradually come up with recording on the HD and dubbing can end early.

Even when, for example, the recording capacity of the optical disc is filled up or the residual amount of the optical disc becomes slight on account of the high dubbing speed, causing recording on the optical disc to be paused, the pause position is memorized so that dubbing can be started from the pause position immediately after optical disc exchange and can overtake recording on the HD. After the dubbing ends, the same data image signal can be recorded on both the HD and the DVD. The disc exchange during the dubbing can be carried out by exchanging the disc during recording of the same data image signal on both the HD and the DVD or by performing mere disc exchange during dubbing as usual.

It should be further understood by those skilled in the art that although the foregoing description has been made on embodiments of the invention, the invention is not limited thereto and various changes and modifications may be made without departing from the spirit of the invention and the scope of the appended claims.

1. A visual and audio data recording and reproducing apparatus comprising:
input means for inputting external visual and audio data;
first and second temporary storage media for temporarily holding the visual and audio data inputted by said input means;
first recording means for recording the visual and audio data from said first temporary storage medium on a first recording medium;
second recording means for recording the visual and audio data from said second temporary storage medium on a second recording medium; and
control means for controlling said input means, said first temporary storage medium, said second temporary storage medium, said first recording means and said second recording means,
wherein said control means pauses recording on said second recording medium when said visual and audio data is recorded on said first recording medium and pauses recording on said first recording medium when said visual and audio data is recorded on said second recording medium, whereby said visual and audio data is recorded by repeating recording on said first recording medium and pause thereof and recording on said second recording medium and pause thereof.

2. A visual and audio data recording and reproducing apparatus according to claim 1, wherein said first and second recording media are of different kinds.

3. A visual and audio data recording and reproducing apparatus according to claim 1, wherein at least one of said first and second recording media is a mountable/dismountable medium.

4. A visual and audio data recording and reproducing apparatus according to claim 1 further comprising power supply connection means capable of receiving electric power supplied from first and second power supplies and output means,
wherein said control means monitors the accumulation amount of said first power supply so as to permit said first power supply to be used and causes, when the accumulation amount of said first power supply falls below a predetermined value, said output means to inform a user that electric power is to be supplied from said second power supply.

5. A visual and audio data recording and reproducing apparatus comprising:
input means for inputting external visual and audio data;
first and second temporary storage media for temporarily holding the visual and audio data inputted by said input means;
first recording means for recording the visual and audio data from said first temporary storage medium on a first recording medium;
second recording means for recording the visual and audio data from said second temporary storage medium on a second recording medium; and
control means for controlling said input means, said first temporary storage medium, said second temporary storage medium, said first recording means and said second recording means, wherein
said control means records said visual and audio data on said first recording medium by repeating recording and pause and records said visual and audio data on said second recording medium continuously at a low recording speed.

6. A visual and audio data recording and reproducing apparatus according to claim 5, wherein said first and second recording media are of different kinds.

7. A visual and audio data recording and reproducing apparatus according to claim 5, wherein at least one of said first and second recording media is a mountable/dismountable medium.

8. A visual and audio data recording and reproducing apparatus according to claim 5 further comprising power supply connection means capable of receiving electric power supplied from first and second power supplies and output means,
wherein said control means monitors the accumulation amount of said first power supply so as to permit said first power supply to be used and causes, when the accumulation amount of said first power supply falls below a predetermined value, said output means to inform a user that electric power is to be supplied from said second power supply.

9. A visual and audio data recording and reproducing apparatus comprising:
input means for inputting external visual and audio data;
first and second temporary storage media for temporarily holding the visual and audio data inputted by said input means;
first recording means for recording the visual and audio data from said first temporary storage medium on a first recording medium;
second recording means for recording the visual and audio data from said second temporary storage medium on a second recording medium; and
control means for controlling said input means, said first temporary storage medium, said second temporary storage medium, said first recording means and said second recording means, wherein
when said visual and audio data is recorded on said first and second recording media and then recording on said second recording medium is paused, said control means makes a pause while holding a pause position indicating how far recording of said visual and audio data on said second recording medium has proceeded and continuing recording on said first recording medium.

10. A visual and audio data recording and reproducing apparatus according to claim 9, wherein said control means monitors a recording permissible residual amount of said second recording medium and when the recording permissible residual amount of said second recording medium is less than a predetermined value, recording on said first recording medium is allowed to continue and recording on said second recording medium is paused.

11. A visual and audio data recording and reproducing apparatus according to claim 9 further comprising power supply connection means capable of receiving electric power supplied from a power supply, wherein said control means monitors the accumulation amount of said power supply so as to permit recording on said first recording medium to continue and cause recording on said second recording medium to pause when the accumulation amount of said power supply falls below a predetermined value.

12. A visual and audio data recording and reproducing apparatus according to claim 9, wherein said second medium is an exchangeable medium and wherein said visual and audio data recorded on said first recording medium is reproduced and stored in said second temporary storage medium, and recording of data succeeding said pause position from said second temporary storage medium on a replaced second recording medium is continuously taken over.

13. A visual and audio data recording and reproducing apparatus according to claim 12, wherein recording, on said first recording medium, of visual and audio data said first temporary storage medium has obtained from said input means is executed at a first average recording speed and recording, on said second recording medium, of visual and audio data said second temporary storage medium has obtained from said first recording medium is executed at a second average speed, said second average recording speed being faster than said first average recording speed.

14. A visual and audio data recording and reproducing apparatus according to claim 12, wherein recording on said second recording medium is either executed by repeating recording and pause or executed continuously at a low recording speed.

15. A visual and audio data recording and reproducing apparatus comprising:
input means for inputting external visual and audio data;
a first temporary storage medium for temporarily holding the visual and audio data inputted by said input means;
a second temporary storage medium;
first recording means for recording the visual and audio data from said first temporary storage medium on a first recording medium;
second recording means for recording the visual and audio data from said first recording medium on a second recording medium; and
control means for controlling said input means, said first temporary storage medium, said second temporary storage medium, said first recording means and said second recording means, wherein
said control means performs such a control operation that data held by said first recording medium is reproduced, stored in said second temporary storage medium and recorded from said second temporary storage medium on said second recording medium and that when recording on said second recording medium is paused, a pause position indicating how far recording of said data held by said first recording medium on said second recording medium has proceeded is held and a pause is then taken.

16. A visual and audio data recording and reproducing apparatus according to claim 15, wherein said control means monitors a recording permissible residual amount of said second recording medium and when the recording permissible residual amount of said second recording medium falls below a predetermined value, recording on said second recording medium is paused.

17. A visual and audio data recording and reproducing apparatus according to claim 15 further comprising power supply connection means capable of receiving electric power supplied from a power supply, wherein said control means monitors the accumulation amount of said power supply so as to pause recording on said second recording medium when the accumulation amount of said power supply falls below a predetermined value.

18. A visual and audio data recording and reproducing apparatus according to claim 15, wherein said second medium is an exchangeable medium and wherein said visual and audio data recorded on said first recording medium is reproduced and stored in said second temporary storage medium and wherein recording of data succeeding said pause position from said second temporary storage medium on a replaced second recording medium is continuously taken over.

19. A visual and audio recording and reproducing apparatus according to claim 18, wherein recording on said second recording medium is either executed by repeating recording and pause or executed continuously at a low recording speed.

20. A visual and audio recording and reproducing apparatus according to claim 1, wherein said first and second temporary storage media are merged into an integral memory.
